(19) United States
(12) Patent Application Publication
(10) Pub. No.: US 2019/0057703 A1
(43) Pub. Date: Feb. 21, 2019

(54) VOICE ASSISTANCE SYSTEM FOR DEVICES OF AN ECOSYSTEM

(71) Applicant: Faraday&Future Inc., Gardena, CA (US)

(72) Inventor: Mark Lewis Zeinstra, Holland, MI (US)

(21) Appl. No.: 16/080,662

(22) PCT Filed: Feb. 29, 2016
(86) PCT No.: PCT/US2017/020031

§ 371 Date: Aug. 28, 2018

Related U.S. Application Data
(60) Provisional application No. 62/301,555, filed on Feb. 29, 2016.

(51) Int. Cl. G10L 15/30; G10L 15/22; G10L 17/00

(52) U.S. Cl. CPC G10L 15/30; G10L 2015/223; G10L 17/00; G10L 15/22

(57) ABSTRACT

A voice assistance system may include an interface configured to receive a signal indicative of a voice command made to a first device. The system may also include at least one processor configured to: extract an action to be performed according to the voice command, locate a second device implicated by the voice command to perform the action, access data related to the second device from a storage device based on the voice command, and generate a control signal based on the data for actuating a control on at least one of the first device and the second device according to the voice command.

### TECHNICAL FIELD

The present disclosure relates generally to a personal assistance system, and more particularly, to a universal voice recognition system acting as a personal assistance for a plurality of devices of an ecosystem.

### BACKGROUND

Voice recognition software enables a user to access local and Internet data of a device based on verbal commands. For example, voice recognition software has been applied to mobile devices (e.g., smart phones) and enabled the user to access personal contacts or retrieve data from the Internet in response to verbal requests of the user. Different versions of the voice recognition software have also been applied to other devices, such as televisions, desktop assistants, and vehicles.

The software provides a number of benefits, such as allowing a driver to control media or search for information hands-free. However, the versions of software are divergent and stand-alone systems, not interconnected between different devices belonging to the same person or group of people. The lack of integration prevents the user from controlling different devices, and hinders the software from learning speech input, habits, and context of the voice commands. Accordingly, it would be advantageous to provide a voice recognition system integrated into a plurality of devices within an ecosystem to make it more convenient for a user to interact with these devices.

The disclosed voice recognition system is directed to mitigating or overcoming one or more of the problems set forth above and/or other problems in the prior art.

### SUMMARY

One aspect of the present disclosure is directed to a voice assistance system for a plurality of devices connected to a network. The system may include an interface configured to receive a signal indicative of a voice command made to a first device. The system may also include at least one processor configured to: extract an action to be performed according to the voice command, locate a second device implicated by the voice command to perform the action, access data related to the second device from a storage device based on the voice command, and generate a control signal based on the data for actuating a control on at least one of the first device and the second device according to the voice command.

Another aspect of the present disclosure is directed to a method of voice assistance. The method may include receiving, with an interface, a signal indicative of a voice command made to a first device, extracting, with at least one processor, an action to be performed according to the voice command, and locating, with at least one processor, a second device implicated by the voice command to perform the action. The method may also include accessing, with the at least one processor, data related to the second device from a storage device based on the voice command, and generating, with the at least one processor, a control signal based on the data for actuating a control on at least one of the first device and the second device according to the voice command.

Yet another aspect of the present disclosure is directed to a non-transitory computer-readable medium storing instructions which, when executed, cause one or more processors to perform a method of remote control of a vehicle. The method may include receiving a signal indicative of a voice command made to a first device, extracting an action to be performed according to the voice command, and locating a second device implicated by the voice command to perform the action. The method may also include accessing data related to a second device from a storage device based on the voice command, and generating a control signal based on the data for actuating a control on at least one of the first device and the second device according to the voice command.

### BRIEF DESCRIPTION OF THE DRAWINGS

FIG. 1 is a diagrammatic illustration of an exemplary embodiment of an exemplary voice assistance system, according to an exemplary embodiment of the disclosure.

FIG. 2 is a diagrammatic illustration of an exemplary embodiment of an exemplary vehicle that may be used with the exemplary voice assistant system of FIG. 1, according to an exemplary embodiment of the disclosure.

FIG. 3 is a diagrammatic illustration of an exemplary embodiment of an exemplary mobile device that may be used with the exemplary voice assistant system of FIG. 1, according to an exemplary embodiment of the disclosure.

FIG. 4 is a block diagram of the exemplary voice assistant system of FIG. 1, according to an exemplary embodiment of the disclosure.

FIG. 5 is a flowchart illustrating an exemplary process that may be performed by the exemplary remote control system of FIG. 1, according to an exemplary embodiment of the disclosure.

### DETAILED DESCRIPTION

The disclosure is generally directed to a voice assistance system that may provide seamless cloud-based personal assistance between a plurality of devices of an ecosystem. For example, the ecosystem may include Internet of Things (IoT) devices, such as a mobile device, a personal assistant device, a television, an appliance, a home electronic device, and/or a vehicle belonging to the same person or group of people. The cloud-based voice assistance system may provide a number of advantages. For example, in some embodiments, the voice assistance system may assist users finding connected content for each of the plurality of devices. In some embodiments, the voice assistance system may facilitate monitoring and control of the plurality of devices. In some embodiments, the voice assistance system may learn voice signatures and patterns and habits of the users associated with the ecosystem. In some embodiments, the voice assistance system may provide intelligent personal assistance based on context and learning

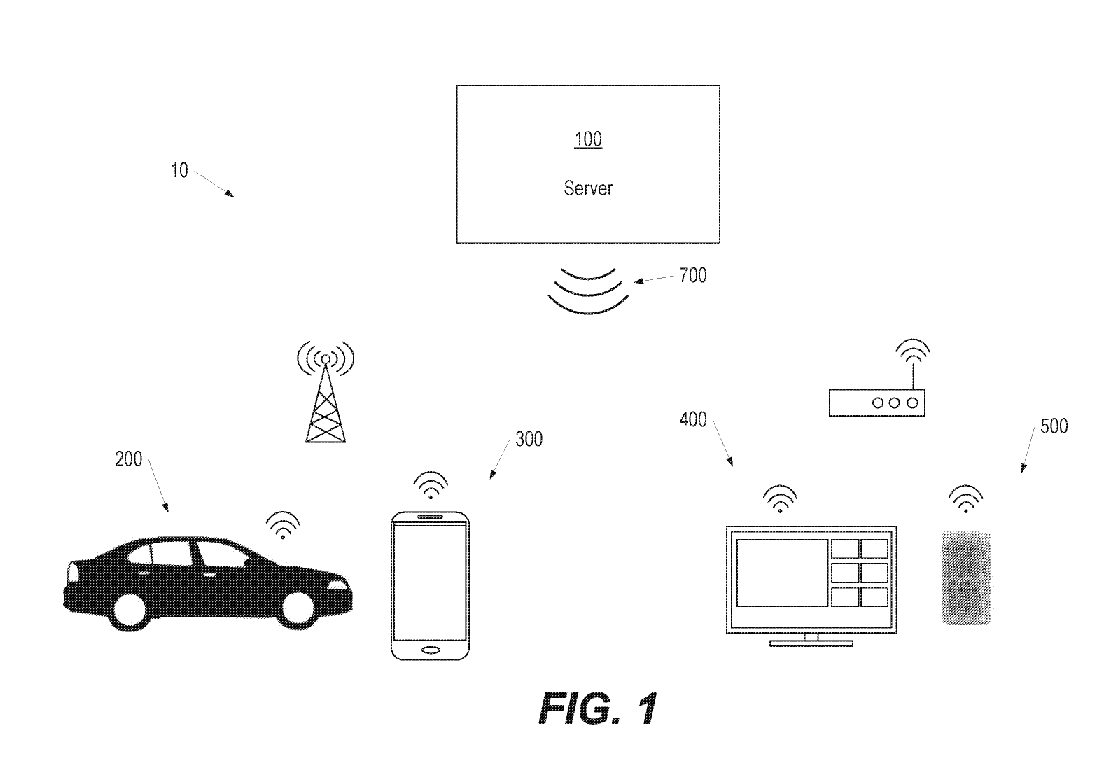

FIG. 1 is a diagrammatic illustration of an exemplary embodiment of an exemplary voice assistance system 10, according to an exemplary embodiment of the disclosure.

As illustrated in FIG. 1, voice assistance system 10 may include a server 100 connected to a plurality of devices 200-500 via a network 700. Devices 200-500 may include a vehicle 200, a mobile device 300, a television 400, and a personal assistant device 500. It is contemplated that devices 200-500 may also include one or more kitchen appliances, such as refrigerators, freezers, stoves, microwaves, toasters, and blenders. It is also contemplated that devices 200-500 may further include other home electronic devices, such as thermostats, carbon monoxide sensors, vent controls, security systems, garage door openers, door sensors, and window sensors. It is further contemplated that devices 200-500 may further include other personal electronic devices, such as computers, tablets, music players, video players, cameras, wearable devices, robots, fitness monitoring devices, and exercise equipment.

In some embodiments, server 100 may be implemented in a cloud network of one or more server(s) 100. For example, the cloud network of server(s) 100 may combine the computational power of a large grouping of processors and/or combine the storage capacity of a large grouping of computer memories or storage devices. Server(s) 100 of cloud network may collectively provide processors and storage devices that manage workloads of a plurality of devices 200-500 owned by a plurality of users. Typically, each user places workload demands on the cloud that vary in real-time, sometimes dramatically, such that server(s) 100 may balance the load across the processors enabling efficient operation of devices 200-500. Server(s) 100 may also include partitioned storage devices, such that each user may securely upload and access private data, for example, across an ecosystem of devices 200-500. Servers 100 may be located in a remote facility and may communicate with devices 200-500 through web browsers and/or application software (e.g., apps) via network 700.

Network 700 may include a number of different types of networks enabling the exchange of signals and data between server 100 and devices 200-500. For example, network 700 may include radio waves, a nationwide cellular network, a local wireless network (e.g., Bluetooth™, WiFi, or LoFi), and/or a wired network. Network 700 may be transmitted over satellites, radio towers (as shown in FIG. 1), and/or routers (as shown in FIG. 1). As depicted in FIG. 1, network 700 may include a nationwide cellular network that enables communication with vehicle 200 and mobile device 300, and a local wireless network that enables communication with television 400 and personal assistant device 500. It is also contemplated that home appliances and other home electronic devices may be in communication with the local network.

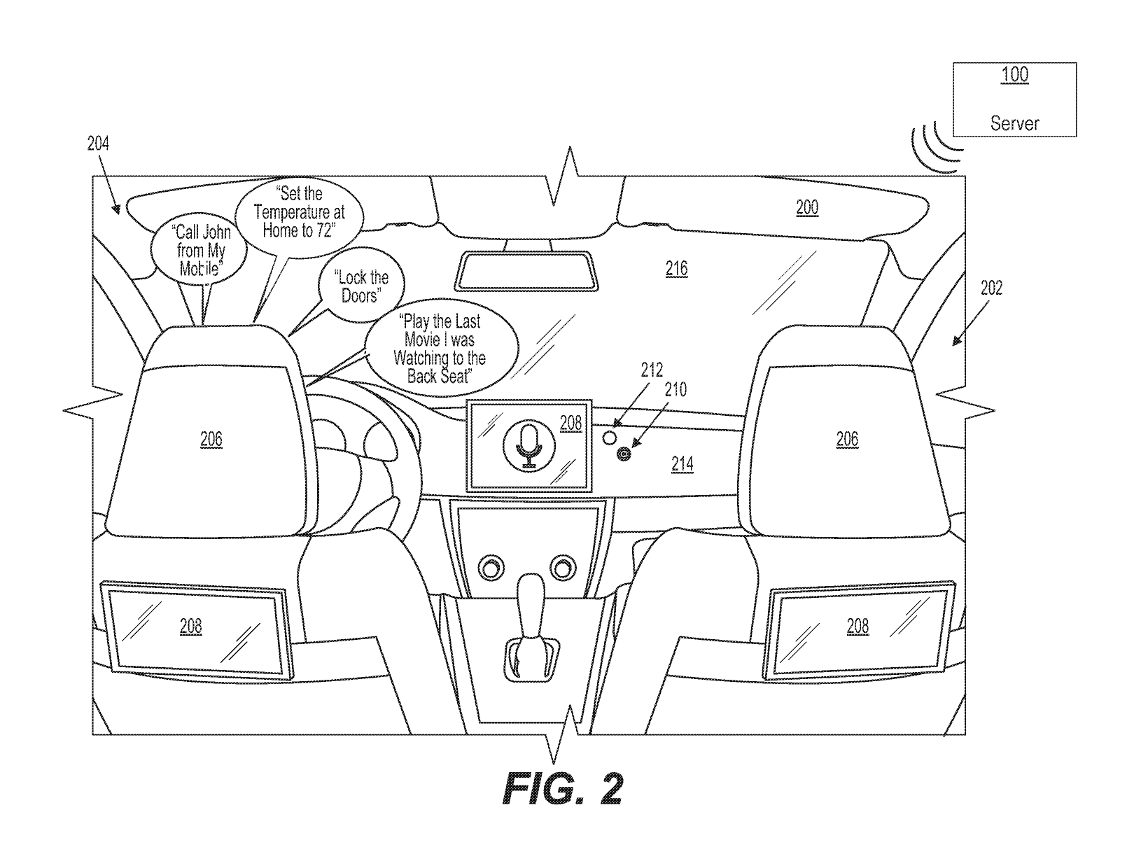

Each device 200-500 may be configured to receive voice commands and transmit signals to server 100 via network 700. For example, each device 200-500 may include a microphone (e.g., microphone 210 of FIG. 2) configured to receive voice commands from a user and generate a signal indicative of the voice command. It is also contemplated that each device 200-500 may include cameras (e.g., camera 212 of FIG. 2) configured to capture non-verbal commands, such as facial expressions and/or hand gestures. The commands may be processed according to voice and/or image recognition software to identify the user and to extract content of the command, such as the desired operation and the desired object of the command (e.g., device 200-500).

In some embodiments, devices 200-500 may collectively form an ecosystem. For example, devices 200-500 may be associated with one or more common users and enable seamless interaction across devices 200-500. Devices 200-500 of an ecosystem may include devices manufactured by a common manufacturer and executing a common operating system. Devices 200-500 may also be devices manufactured by different manufacturers and/or executing different operating systems, but designed to be compatible with each other. Devices 200-500 may be associated with each other through the interaction with one or more common users, for example, devices 200-500 of an ecosystem may be configured to connect and share data through interaction with voice assistance system 10. Devices 200-500 may be configured to access common application software (e.g., apps) of server 100 based on interaction with a common user. Devices 200-500 may also enable the user to control devices 200-500 across the ecosystem. For example, a first device (e.g., mobile device 300) may be configured to receive a voice command to control the operation of a second device (e.g., vehicle 200). For instance, the first device may be configured to interact with server 100 to access data associated with the second device, such as data from sensors of vehicle 200 to be outputted to mobile device 300. The first device may also be configured to interact with server 100 to initiate control signals to the second device, such as opening doors of vehicle 200, initiating autonomous driving functions of vehicle 200, and/or outputting video or audio media data to vehicle 200.

In some embodiments, the interaction between devices 200-500 of an ecosystem may be enabled through voice recognition. For example, voice recognition system 10 may provide access and control of an ecosystem of devices 200-500 based on recognition of voice signature and/or patterns of authorized users. For instance, if a first device receives a voice command “OPEN THE DOORS TO MY CAR,” server 100 may be configured to recognize the voice signature and/or patterns to identify the user, find vehicle 200 on network 700 associated with the identified user, determine whether the user is authorized, and control vehicle 200 based on an authorized voice command. Authorization based on voice recognition of voice recognition system 10 may enhance connectivity of an ecosystem of devices 200-500 while maintaining security.

In some embodiments, server 100 may also be configured to aggregate data related to the user through interaction with devices 200-500 of the ecosystem and conduct computer learning of speech signatures and/or patterns to enhance recognition of the identity of the user and recognition of the content of the voice commands. Server 100 may further aggregate other data acquired by devices 200-500 to interactively learn habits of users to enhance the interactive experience. For example, server 100 may be configured to acquire GPS data from one or more devices (e.g., mobile device 300) and media data from one or more devices (e.g., vehicle 200), and server 100 may be configured to provide suggestions to the user via devices 200-500 based on the aggregated data. Devices 200-500 may further be configured to access data associated with the user stored in storage device of server 100.

FIG. 2 is a diagrammatic illustration of an exemplary embodiment of an exemplary vehicle 200 that may be used with voice assistance system 10 of FIG. 1, according to an exemplary embodiment of the disclosure. Vehicle 200 may have any body style, such as a sports car, a coupe, a sedan, a pick-up truck, a station wagon, a sports utility vehicle (SUV), a minivan, or a conversion van. Vehicle 200 may be an electric vehicle, a fuel cell vehicle, a hybrid vehicle, or a conventional internal combustion engine vehicle. Vehicle 200 may be configured to be operated by a driver occupying vehicle 200, remotely controlled, and/or autonomously.

As illustrated in FIG. 2, vehicle 200 may include a plurality of doors 202 that may allow access to a cabin 204, and each door 202 may be secured with respective locks (not shown). Vehicle 200 may also include a plurality of seats 206 that accommodate one or more occupants. Vehicle 200 may also include one or more displays 208, a microphone 210, a camera 212, and speakers (not shown).

Displays 208 may include any number of different structures configured to display media (e.g., images and/or video) transmitted from server 100. For example, displays 208 may include LED, LCD, CRT, and/or plasma monitors. Displays 208 may also include one or more projectors that project images and/or video onto a surface of vehicle 200. Displays 208 may be positioned at a variety of locations of vehicle 200. As illustrated in FIG. 2, displays 208 may be positioned on a dashboard 214 to be viewed by occupants of seats 206, and/or positioned on a back of seats 206 to be viewed by occupants of back seats (not shown). In some embodiments, one or more of displays 208 may be configured to display data to people outside of vehicle 200. For example, displays 208 may be positioned in, on, or around an exterior surface of vehicle 200, such as a panel, a windshield 216, a side window, and/or a rear window. In some embodiments, displays 208 may include a projector that projects images and/or video onto a tailfin (not shown) of vehicle 200.

Microphone 210 and camera 212 may be configured to capture audio, images, and/or video data from occupants of cabin 204. For example, as depicted in FIG. 2, microphone 210 may be configured to receive voice commands such as “CALL JOHN FROM MY MOBILE,” “SET THE TEMPERATURE AT HOME TO 72,” “LOCK THE DOORS,” or “PLAY THE LAST MOVIE I WAS WATCHING TO THE BACK SEAT.” The voice commands may provide instructions to control vehicle 200, or any other device of the ecosystem, such as devices 300-500.

For example, when an occupant says “CALL JOHN FROM MY MOBILE” to vehicle 200, Microphone 210 may generate a signal indicative of the voice commands to be transmitted from an on-board controller or computer (not shown) to server 100 (as depicted in FIG. 1). Server 100 may then access data from a storage device implicated in the voice commands. For example, server 100 may access a contact list from a storage device of mobile device 300. Server 100 may also identify the person based on the voice commands, or in combination with other personal information, such as biometric data collected by vehicle 200. Server 100 may then locate the person's mobile phone connected to network 700, and transmit the contact information to mobile device 300 of the user to conduct the desired telephone call.

As another example, when the voice command is to “SET THE TEMPERATURE AT HOME TO 72,” server 100 may locate the thermostat located in the person's home. Server 100 may also transmit a control signal to the thermostat to alter a temperature of the house. As a further example, when the occupant instructs “PLAY THE LAST MOVIE I WAS WATCHING TO THE BACK SEAT,” server 100 may determine which device (e.g., mobile device 300 or television 400) was last outputting media data (e.g., a movie), locate that mobile device 300 or television 400 on network 700, access the media data, and transmit the media data to displays 208 of the back seat. Along with the media data, server 100 may also provide additional information such as the timestamp in the media data where the occupant stopped watching on the other device. In some embodiments, server 100 may only transmit the media data to displays 208 based on recognition of voice commands of authorized users (e.g., parents), for example, providing parental controls for devices 200-500, such as vehicle 200.

It is also contemplated that cameras of devices 200-500 may be configured to capture non-verbal commands, such as facial expressions and/or hand gestures, and generate and transmit signals to server 100. For example, in some embodiments, camera 212 may continually capture video and/or images of the occupants of vehicle 200, and server 100 may compare the captured video and/or images to profiles of known users to determine an identity of the occupant. Server 100 may also extract content from the non-verbal commands by comparing the video and/or images to representations of known commands. For example, server 100 may generate the control signals according to preset non-verbal commands, such as the occupant raising an index finger may cause serve 100 to generate and transmit a control signal to a thermostat to altering the climate of a house to a predetermined temperature. It is also contemplated that the camera of the devices 200-500 may only be activated based a precedential actuation, such as pushing a button on a steering wheel of vehicle 200.

Vehicle 200 may also include a powertrain (not shown) having a power source, a motor, and a transmission. In some embodiments, power source may be configured to output power to motor, which drives transmission to generate kinetic energy through wheels of vehicle 200. Power source may also be configured to provide power to other components of vehicle 200, such as audio systems, user interfaces, heating, ventilation, air conditioning (HVAC), etc. Power source may include a plug-in battery or a hydrogen fuel-cell. It is also contemplated that, in some embodiments, powertrain may include or be replaced by a conventional internal combustion engine. Each of the components of powertrain may be remotely controlled and/or perform autonomous functions, such as self-drive, self-park, and self-retrieval, through communication with server 100.

Vehicle 200 may further include a steering mechanism (not shown). In some embodiments, steering mechanism may include a steering wheel, a steering column, a steering gear, and a tie rod. For example, the steering wheel may be rotated by an operator, which in turn rotates the steering column. The steering gear may then convert the rotational movement of the steering column to lateral movement, which turns the wheels of vehicle 200 by movement of the tie rod. Each of the components of steering mechanism may also be remotely controlled and/or perform autonomous functions, such as self-drive, self-park, and self-retrieval, through communication with server 100.

Vehicle 200 may even further include a plurality of sensors (not shown) functionally associated with its components, such as powertrain and steering mechanism. For example, the sensors may monitor and record parameters such as speed and acceleration of vehicle 200, stored energy of power source, operation of motor, and function of steering mechanism. Vehicle 200 may also include other cabin sensors, such as thermostats and weight sensors, configured to acquire parameters of the occupants of cabin. The data from the sensors may be aggregated and processed according to software, algorithms, and/or look-up tables to determine conditions of vehicle 200. For example, cameras 212 may acquire data indicative of the identities of the occupants when an image is processed with image recognition software. The data may also indicate whether predetermined conditions of vehicle 200 are occurring or have occurred, according to algorithms and/or look-up tables. For example, server 100 may process the data from the sensors to determine conditions, such as an unattended child left in vehicle 200, vehicle 200 being operated recklessly or by a drunken driver, and/or occupants not wearing a seat belt. The data and conditions may be aggregated and processed by server 100 to generate appropriate control signals.

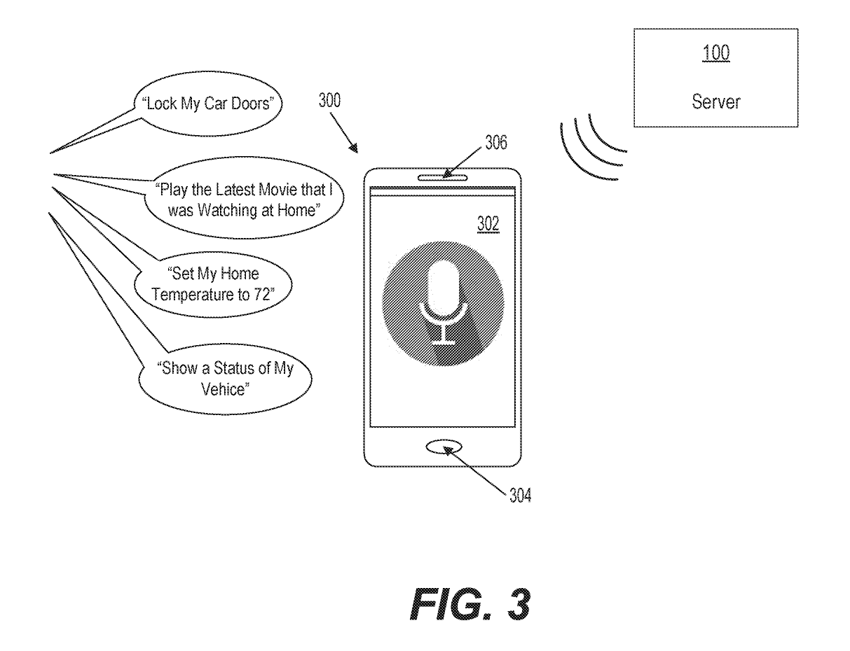

FIG. 3 is a diagrammatic illustration of an exemplary embodiment of an exemplary mobile device 300 that may be used with the voice assistance system 10 of FIG. 1, according to an exemplary embodiment of the disclosure.

As illustrated in FIG. 3, mobile device 300 may include a display 302, a microphone 304, and a speaker 306. Similar to vehicle 200 of FIG. 2, mobile device 300 may be configured to receive voice commands, via microphone 304, and generate a signal that is directed to server 100. Server 100 may responsively transmit control signals to devices 200-500. Server 100 may also generate a visual response onto the display 302 or a verbal response through speaker 306. For example, voice commands received by mobile device 300 may include any number of functions, such as “LOCK MY CAR DOORS,” “PLAY THE LATEST MOVIE THAT I WAS WATCHING AT HOME,” “SET MY HOME TEMPERATURE TO 72,” and “SHOW ME A STATUS OF MY VEHICLE,” as illustrated in FIG. 3. Microphone 304 may be configured to receive the voice commands, and generate a signal to server 100. Server 100 may be configured to process the signal to recognize an identity of the user and extract content from the voice commands. For example, server 100 may compare the voice signature and/or pattern of the received signal with known users, such as the owner of mobile device 300, to determine authorization. Server 100 may also extract content to determine the desired function of the voice command. For example, if server 100 receives a signal indicative of the voice command “LOCK MY CAR DOORS,” server 100 may determine whether the user is authorized to perform the function, server 100 may locate vehicle 200 on network 700, and generate and transmit a control signal to vehicle 200. Server 100 may process the other voice commands in a similar manner.

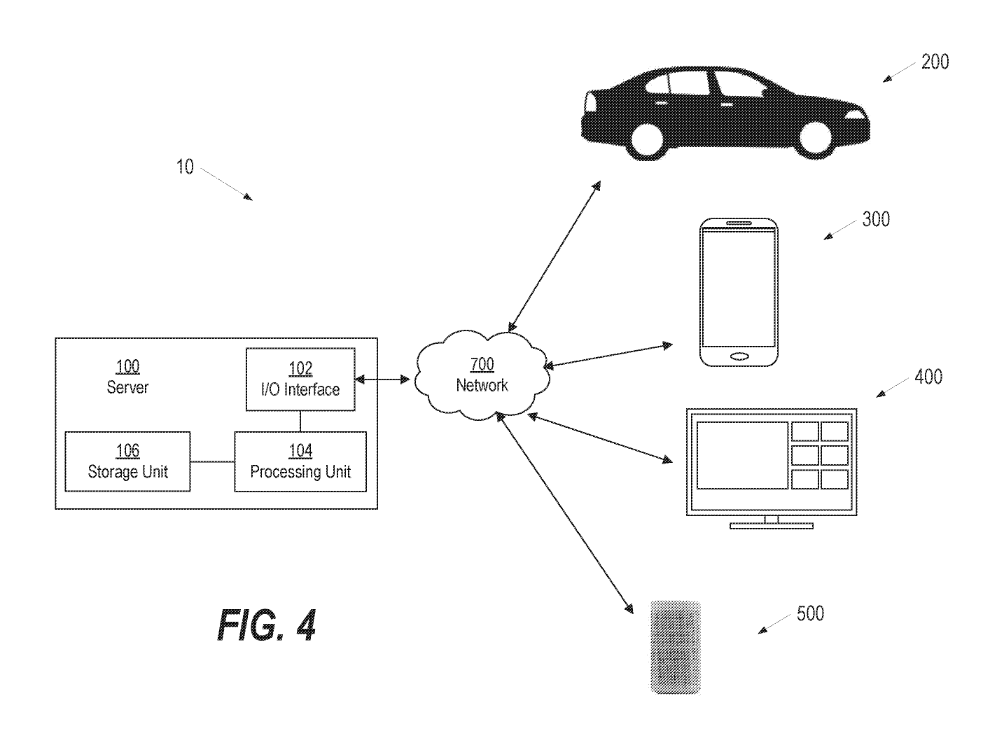

FIG. 4 is a block diagram of an exemplary server 100 that may be used with the exemplary voice assistance system 10 of FIG. 1, according to an exemplary embodiment of the disclosure. As illustrated in FIG. 4, server 100 may include, among other things, an I/O interface 102, a processor 104, and a storage device 106. One or more of the components of server 100 may reside on a cloud server remote from devices 200-500, or positioned within one of devices 200-500, such as in an on-board computer of vehicle 200. It is also contemplated that each component may be implemented using multiple physical devices at different physical locations, e.g., when server 100 is a cloud network of server(s) 100. These units may be configured to transfer data and send or receive instructions between or among each other. I/O interface 102 may include any type of wired and/or wireless link or links for two-way transmission of signals between server 100 and devices 200-500. Devices 200-500 may include similar components (e.g., an I/O interface, a processor, and a storage unit), which are not depicted for clarity sake. For example, vehicle 200 may include an on-board computer which incorporates an I/O interface, a processor, and a storage unit.

Processor 104 may include any type of single or multi-core processor, mobile device microcontroller, central processing unit, etc. For example, processor 104 may include a microprocessor, preprocessors (such as an image preprocessor), graphics processors, a central processing unit (CPU), support circuits, digital signal processors, integrated circuits, memory, or any other types of devices suitable for running applications and for signal processing and analysis. Various processing devices may be used, including, for example, processors available from manufacturers such as Intel®, AMD®, etc. and may include various architectures (e.g., x86 processor, ARM®, etc.).

Processor 104 may be configured to aggregate data and process signals to determine a plurality of conditions of the voice assistance system 10. Processor 104 may also be configured to receive and transmit command signals, via I/O interface 102, in order to actuate devices 200-500 in communication. For example, a first device (e.g., mobile device 300) may be configured to transmit a signal to I/O interface 102 indicative of a voice command. Processor 104 may be configured to process the signal to apprehend the voice command, and communicate with a second device (e.g., vehicle 200) in accordance with the voice command. Processor 104 may also be configured to generate and transmit control signals to one of the first device or the second device. For example, mobile device 300 may receive a voice command from a user, such as “PULL MY CAR AROUND,” via microphone 304. Mobile device 300 may process the voice command and generate a signal to server 100. Server 100 may compare the signal to biometric data (e.g., speech signatures and/or patterns) to determine the identity of the user, and compare the determined identity to users with authorization to operate vehicle 300. Based on authorization, server 100 may extract content of the voice command to determine the desired function, and locate vehicle 200 on network 700. Server 100 may also generate and transmit a control signal to vehicle 200 in order to perform the desired function.

In some embodiments, the second device may also be configured to transmit a second signal to I/O interface indicative of a second voice command. Processor 104 may be configured to process the second signal to apprehend the second voice command, and communicate with the first device in accordance with the second voice command. Processor 104 may be further configured to generate and transmit second control signals to one of the first device or the second device based on the second voice command. For example, vehicle 200 may receive a voice command from a user, such as “TEXT CATHERINE FROM MY CELL PHONE,” via microphone 210. Vehicle 200 may process the voice command and generate a signal to server 100. Server 100 may compare the signal to biometric data (e.g., speech signatures and/or patterns) to determine the identity of the user, and compare the determined identity to users with authorization to operate mobile device 300. Based on authorization, server 100 may extract content of the voice command to determine the desired function, and locate mobile device 300 on network 700. Server 100 may also generate and transmit a control signal to mobile device 300 in order to perform the desired function.

Therefore, the user may transmit data and/or remotely control each device 200-500 through verbal commands received by at least one of devices 200-500. Accordingly, the cloud-based voice assistance system 10 may enhance the access of data and control of devices 200-500.

In some embodiments, when a verbal command from the first device implicates the second device, server 100 may be configured to locate the second device on network 700 based on the information provided in the voice command. For example, when the second device is explicitly stated in the voice command, such as “CLOSE MY GARAGE DOOR,” server 100 may be configured to recognize the keyword “GARAGE DOOR” based on data of storage unit 106, and transmit a control signal to the garage door opener. However, when there are multiple second devices with a similar name, such as “MY MOBILE PHONE,” processor 104 may be configured to first determine the identity of the person providing the voice commands. Processor 104 may then identify and locate the second device that is associated with the person, such as mobile device 300 associated with the user providing the voice command. Alternatively, “MY MOBILE DEVICE” may be located by searching for mobile device 300 in the same ecosystem with the first device, such as a vehicle 200. When the second device is not explicit from the voice command, processor 104 may be configured to extract circumstantial content from the voice command to determine which devices 200-500 are being implicated. For example, when the second device is not explicitly identified, but implied, such as in “SET MY HOME TEMPERATURE TO 70 DEGREES,” processor 104 may determine that a thermostat is the second device to be controlled based on the keyword “home temperature” being associated with the thermostat according to data of storage device 106. Furthermore, processor 104 may be configured to receive additional information by generating and transmitting visual and/or verbal prompts to the user through device 200-500.

In some embodiments, when the voice command implicates the control on the first device based on information related to the second device, processor 104 may be configured to acquire the information from storage device 106 related to the second device, prepare data based on the information, and transmit the control signal and the data to the first device to actuate the control. For example, processor 104 may perform this function in response to voice commands, such as “PLAY THE LAST MOVIE I WATCHED ON TV” or “SHOW ME A STATUS REPORT OF MY CAR.” Processor 104 may be configured to determine which devices 200-500 may have the desired data stored, and access the data to be displayed on the desired device 200-500.

In some embodiments, server 100 may assist the user to find connected content for devices 200-500. Server 100 may be configured to recognize an identity of a user based on his/her voice signatures and/or pattern, by comparing signals of voice commands to known voice signatures and/or patterns stored in look-up tables. Server 100 may be configured to recognize which of devices 200-500 are associated with the user based on data stored in storage device 106. Server 100 may also be configured to aggregate the data associated with the user and learn from the user's interactions with devices 200-500. For example, server 100 may be configured to provide intelligent personal assistance by generating recommendations based on context (e.g., location and/or time), stored data, and previous voice commands. In some embodiments, server 100 may be configured to automatically perform functions based on a history of voice commands. For instance, server 100 may be configured to automatically recommend locations of restaurants to the user based on previous voice commands at a current location of vehicle 200 and predetermined time of the day. These functions may be provided by using a cloud-based voice assistance system 10 across devices 200-500, enabling increased data aggregation and computer learning.

Storage device 106 may include any number of random access memories, read only memories, flash memories, disk drives, optical storage, tape storage, removable storage and other types of storage. Storage device 106 may store software that, when executed by the processor, controls the operation of the voice assistance system 100. For example, storage device 106 may store voice recognition software that, when executed, recognize segments of a signal indicative of voice commands. Storage device 106 may also store metadata indicating the source of data and correlating data to users. Storage device 106 may further store look-up tables that provide biometric data (e.g., voice signature and/or pattern, and/or facial feature recognition) that would indicate the identity of a user based on a voice signatures and/or pattern. In some embodiments, storage device 106 may include a database of user profiles based on devices 200-500. For example, storage device 106 may store user profiles that correlate one or more users to devices 200-500, such that the devices 200-500 may be controlled by voice commands of the user(s). For example, storage device 106 may include data providing unique user profiles for each user associated with voice assistance system 10, including authorization levels of one or more devices 200-500. The authorization levels may allow individualized control of certain functions based on the identity of the user. Furthermore, each device 200-500 may be associated with identifying keywords stored in storage device 106, for example, vehicle 200 may be associated with keywords such as “vehicle”, “car”, “Ken's car”, and/or “sports car”. Once registered, each device 200-500 may be configured to receive voice commands from associated users to control other registered devices 200-500, for example, based on recognizing the keywords. The look-up table may provide data determinative of which devices 200-500 are associated to which users and ecosystems. The look-up table may also provide authorizations for known users of devices 200-500. The look-up tables may further store thresholds for predetermined conditions of devices 200-500. In some embodiments, storage device 106 may be implemented as a cloud storage. For example, the cloud network of server(s) 100 may include personal data storage for a user. The personal data may only be accessible to the ecosystem of devices 200-500 associated with the user and/or may be only accessible based on recognition of biometric data (e.g., voice signature and/or pattern, and/or facial feature recognition).

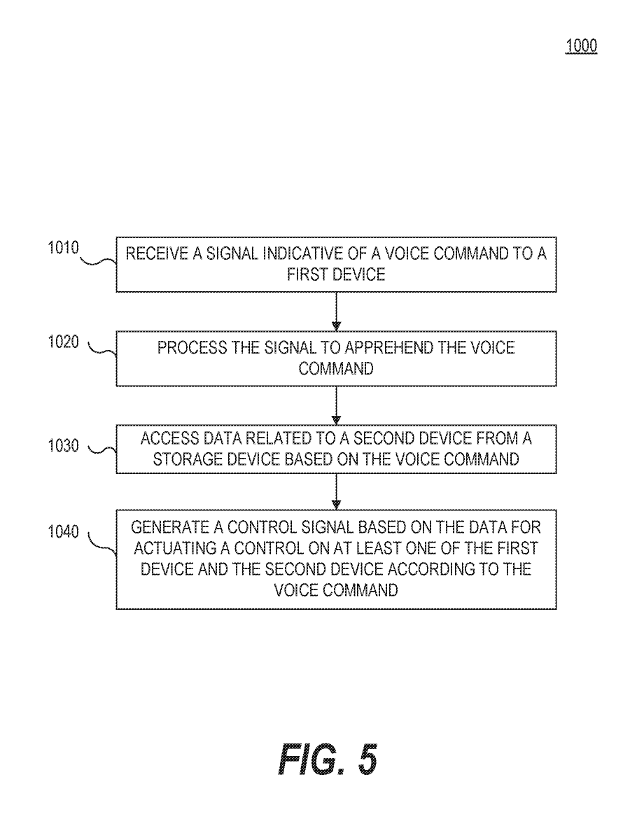

FIG. 5 provides a flowchart illustrating an exemplary method 1000 that may be performed by voice assistance system 10 of FIG. 1.

In step 1010, server 100 may receive a signal indicative of a voice command to a first device. For example, mobile device 300 may be the first device that receives a voice command from a user via microphone 304, such as “PLAY THE LAST MOVIE I WAS WATCHING TO MY MOBILE DEVICE,” or “LOCK MY CAR DOORS.” Mobile device 300 may generate a signal indicative of the voice command that may be transmitted to server 100.

In step 1020, server 100 may process the signal to apprehend the voice command. For example, server 100 may execute voice recognition software to acquire the meaning of the voice command. Server 100 may extract indicative words from the server 100 to determine a desired function and any implicated devices 200-500. Server 100 may also compare the signal with biometric data (e.g., voice signatures and/or patterns) to determine whether the voice command corresponds with any known users. If the voice command is to “PLAY THE LAST MOVIE I WAS WATCHING TO MY MOBILE DEVICE,” server 100 may further query devices 200-500 to determine which device(s) recently played a movie for the known user. If the voice command is to “LOCK MY CAR DOORS,” server 100 may identify and locate the vehicle associated with the known user. In some embodiments, the access of data may be based on the determined user being an authorized user, according to a look-up table.

For example, in some embodiments, step 1020 may include a first sub-step wherein server 100 extracts an action to be performed according to the voice command, and a second sub-step wherein server 100 may extract and locate an object device 200-500 to perform the action of the voice command. For example, server 100 may receive the voice command from a first device 200-500 and extract content from the voice command to determine the desired action and object of the voice command (e.g., a second device 200-500). The second sub-step may include parsing the voice command and comparing verbal expressions of the voice command to keywords (e.g., “home” and “car”) stored in storage device 106. In some embodiments wherein the voice command is ambiguous (e.g., “close door”), the first device 200-500 (e.g., mobile device 300) may prompt the user to determine whether the user wants to close, for example, a garage door or a car door. Mobile device 300 may output the prompt through a visual output on display 302 (e.g., a push notification) and/or a verbal output through speaker 306. Mobile device 300 may responsively receive additional voice commands through microphone 304, and transmit a signal to server 100 to modify the desired command.

In step 1030, server 100 may access data related to a second device from a storage device based on the voice command. For example, to “PLAY THE LAST MOVIE I WAS WATCHING TO MY MOBILE DEVICE,” after determining the location of the data that is being requested by the user, server 100 may access the movie data (e.g., movie) from at least one of storage device 104 or a local storage device of the previous device (e.g., television 400). In the other example, to “LOCK MY CAR DOORS,” server 100 may access data related to the vehicle and its door lock system from storage device 104.

In step 1040, server 100 may generate a command signal based on the data for actuating a control on at least one of the first device and the second device according to the voice command. For example, server 100 may actuate the first device, from which the voice command is received, to display the movie. As another example, server 100 may actuate the second device, e.g., the vehicle to open its doors.

Another aspect of the disclosure is directed to a non-transitory computer-readable medium storing instructions which, when executed, cause one or more processors to perform the methods, as discussed above. The computer-readable medium may include volatile or non-volatile, magnetic, semiconductor, tape, optical, removable, non-removable, or other types of computer-readable medium or computer-readable storage devices. For example, the computer-readable medium may be storage device 106 having the computer instructions stored thereon, as disclosed. In some embodiments, the computer-readable medium may be a disc or a flash drive having the computer instructions stored thereon.

It will be apparent to those skilled in the art that various modifications and variations can be made to the disclosed voice assistance system and related methods. Other embodiments will be apparent to those skilled in the art from consideration of the specification and practice of the disclosed voice assistance system and related methods. It is intended that the specification and examples be considered as exemplary only, with a true scope being indicated by the following claims and their equivalents.

1. A voice assistance system for a plurality of devices connected to a network, the system comprising:
an interface configured to receive a signal indicative of a voice command made to a first device; and
at least one processor configured to:
extract an action to be performed according to the voice command,
locate a second device implicated by the voice command to perform the action,
access data related to the second device from a storage device based on the voice command,
generate a control signal based on the data for actuating a control on at least one of the first device and the second device according to the voice command.

2. The voice assistance system of claim 1, wherein:
the interface is configured to receive a second signal indicative of a second voice command to the second device, and
the at least one processor is configured to:
process the second signal to apprehend the second voice command;
access data related to the first device from the storage device based on the second voice command, wherein the first device is implicated by the voice command, and
generate a control signal based on the data for actuating a control on at least one of the first device and the second device according to the second voice command.

3. The voice assistance system of claim 1, wherein the universal voice recognition system resides on a cloud server, and the storage unit is a cloud storage.

4. The voice assistance system of claim 1, wherein the at least one processor is further configured to recognize a user based on comparing the signal to biometric data.

5. The voice assistance system of claim 4, wherein the at least one processor is further configured to determine whether the recognized user is an authorized user.

6. The voice assistance system of claim 4, wherein the at least one processor is further configured to identify one or more devices associated with the user, including the second device.

7. The voice assistance system of claim 1, wherein the at least one processor is configured to generate a visual or verbal response to be played on the first device.

8. The voice assistance system of claim 1, wherein the voice command implicates the control on the second device, wherein the at least one processor is configured to locate the second device on the network, and transmit the control signal to the second device to actuate the control.

9. The voice assistance system of claim 1,
wherein the voice command implicates the control on the first device based on information related to the second device, and
wherein the at least one processor is configured to:
acquire the information related to the second device,
prepare data based on the information, and
transmit the control signal and the data to the first device to actuate the control.

10. (canceled)

11. The voice assistance system of claim 1, wherein the control to the second device includes open a door of the vehicle, collect data using sensors of the vehicle, media management, or output data on a display of the vehicle.

12. A method of voice assistance, the method comprising:
receiving, with an interface, a signal indicative of a voice command made to a first device;
extracting, with at least one processor, an action to be performed according to the voice command;
locating, with the at least one processor, a second device implicated by the voice command to perform the action;
accessing, with the at least one processor, data related to the second device from a storage device based on the voice command; and
generating, with the at least one processor, a control signal based on the data for actuating a control on at least one of the first device and the second device according to the voice command.

13. The method of claim 12, further comprising:
receiving, with the interface, a second signal indicative of a second voice command to the second device;
processing, with the at least one processor, the second signal to apprehend the second voice command;
access, with the at least one processor, data related to the first device from the storage device based on the second voice command, wherein the first device is implicated by the voice command; and
generating, with the at least one processor, a control signal based on the data for actuating a control on at least one of the first device and the second device according to the second voice command.

14. The method of claim 12, wherein the universal voice recognition system resides on a cloud server, and the storage unit is a cloud storage.

15. The method of claim 12, further comprising recognizing, with the at least one processor, a user based on the signal.

16. The method of claim 15, further comprising determining whether the recognized user is an authorized user.

17. The method of claim 15, further comprising identifying, with the at least one processor, one or more devices associated with the user, including the second device.

18. The method of claim 12, further comprising generating, with the at least one processor, a visual or verbal response to be played on the first device.

19. The method of claim 12, further comprising
locating, with the at least one processor, the second device on the network; and
transmitting, with the interface, the control signal to the second device to actuate the control.

20. The method of claim 12, wherein the controlling the second device includes opening a door of the vehicle, collecting data using sensors of the vehicle, managing media, or outputting data on a display of the vehicle.

21. (canceled)

22. A non-transitory computer-readable medium storing instructions which, when executed, cause one or more processors to perform a method of voice recognition for a plurality of devices, the method comprising:
receiving a signal indicative of a voice command made to a first device;
extracting an action to be performed according to the voice command;
locating a second device implicated by the voice command to perform the action;
accessing data related to the second device from a storage device based on the voice command; and
generating a control signal based on the data for actuating a control on at least one of the first device and the second device according to the voice command.

23. (canceled)
